(19) United States
(12) Patent Application Publication
(10) Pub. No.: US 2022/0017114 A1
(43) Pub. Date: Jan. 20, 2022

(54) Driving Control Device

(71) Applicant: Hitachi Astemo, Ltd., Hitachinaka-shi, Ibaraki (JP)

(72) Inventors: Teppei HIROTSU, Tokyo (JP); Nobuyasu KANEKAWA, Tokyo (JP); Atsushi ARATA, Hitachinaka-shi (JP)

(21) Appl. No.: 17/414,825

(22) PCT Filed: Dec. 4, 2019
(86) PCT No.: PCT/JP2019/047335

§ 371 Date: Jun. 16, 2021

(30) Foreign Application Priority Data
Dec. 17, 2018 (JP) 2018-235500

(51) Int. Cl. B60W 60/00; B60W 50/038

(52) U.S. Cl. CPC B60W 60/0023; B60W 50/038; B60W 2710/06; B60W 2710/20; B60W 2552/15; B60W 2552/05; B60W 2710/244

(57) ABSTRACT

There is no consideration on performing charging control on a battery necessary for limp-home travel according to a travel environment of a vehicle. It is assumed that the vehicle changes a travel lane to a second travel lane by overtaking or the like between time t1 and t0. The second power generation threshold generation unit 33 refers to the lookup table 50 illustrated in FIG. 5 and reads 70 as the second charging threshold SOCth2. Then, the second charging threshold SOCth2 is larger than the first charging threshold SOCth1 as illustrated in FIG. 6(C), and thus, the threshold selection unit 34 outputs the second charging threshold SOCth2 as the selected charging threshold SOCth. At this time, the SOC of the battery is lower than the charging threshold SOCth, and thus, the power generation command value GEN is turned on at time t1, and the power generation engine is started to charge the battery. As a result, when the vehicle is traveling on the second travel lane which is far from an evacuation road 407, a large amount of energy is required for a limp-home operation for returning to the evacuation road 407, and thus, the battery can be sufficiently charged.

### TECHNICAL FIELD

The present invention relates to a driving control device.

### BACKGROUND ART

In recent years, the practical application of autonomous driving of automobiles has been promoted with the development of artificial intelligence technology. In the autonomous driving, a driving control device performs vehicle control, and thus, high safety is required. As one of requirements for safety, there is a fail operation.

In this fail operation, when a part of the driving control device fails, the minimum functions are maintained using the remaining functions instead of immediately stopping all the functions. In the driving control, it is possible to ensure safety as compared with a case where a vehicle immediately stops by enabling the vehicle to move to a safe place and then stop, for example, even if a failure occurs.

PTL1 describes that a travelable distance of a vehicle is calculated based on both stored energy of a battery and a remaining amount of fuel in a fuel tank, and at least one of a process of causing the vehicle to travel in a limp-home mode and a process of notifying that the travelable distance is less than a specified distance is performed when it is determined that the calculated travelable distance is less than the specified distance.

### CITATION LIST

### Patent Literature

PTL 1: JP 2012-101616 A

### SUMMARY OF INVENTION

### Technical Problem

In PTL 1, there is no consideration on performing charging control on a battery necessary for limp-home travel according to a travel environment of a vehicle.

### Solution to Problem

A driving control device according to the present invention includes: an autonomous driving control unit that calculates vehicle behavior information of an autonomous driving vehicle based on travel environment information from a recognition device that recognizes an external environment of the vehicle; and a drive device command generation unit that outputs a command value for controlling a battery or a power generation engine based on the vehicle behavior information from the autonomous driving control unit. The drive device command generation unit outputs a power generation command value to the power generation engine by comparing a charging rate SOC of the battery with a charging threshold SOCth defined based on the travel environment information of the vehicle obtained by the recognition device.

### Advantageous Effects of Invention

According to the present invention, it is possible to perform charging control on a battery necessary for travel in a limp-home mode according to a travel environment of a vehicle.

### BRIEF DESCRIPTION OF DRAWINGS

FIG. 1 is an overall block diagram of a driving control device.

FIG. 2 is a block diagram of an autonomous driving control unit.

FIG. 3 is a block diagram of a drive device command value generation unit.

FIGS. 4(A) and 4(B) are views illustrating an example of a trajectory in a case of overtaking a preceding vehicle.

FIG. 5 is a view illustrating a lookup table referred to by a second power generation threshold generation unit.

FIGS. 6(A) to 6(D) are views illustrating selection of a charging threshold according to a travel lane of a vehicle.

### DESCRIPTION OF EMBODIMENTS

Hereinafter, an embodiment of the present invention will be described with reference to drawings.

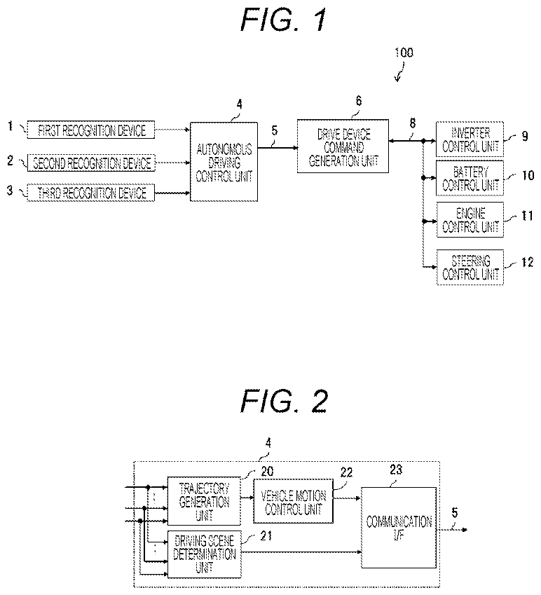

FIG. 1 is an overall block diagram of a driving control device 100 according to the present embodiment. The driving control device 100 includes a first recognition device 1, a second recognition device 2, a third recognition device 3, an autonomous driving control unit 4, a drive device command generation unit 6, an inverter control unit 9, a battery control unit 10, an engine control unit 11, and a steering control unit 12.

The first recognition device 1 is a camera installed on the front, rear, left, and right of a vehicle. The second recognition device 2 is a radar installed on the front, rear, left, and right of the vehicle. The third recognition device 3 outputs road information such as road information and a travel lane with reference to map information based on position information of the vehicle.

The autonomous driving control unit 4 generates a trajectory to avoid a collision with an object based on a travel environment of the vehicle acquired by the first recognition device 1, the second recognition device 2, and the third recognition device 3. Further, a driving scene such as a travel lane is determined, a vehicle behavior command value with ride comfort is calculated, and these pieces of travel information are output to the drive device command generation unit 6 via a communication path 5.

The drive device command generation unit 6 calculates command values for driving the inverter control unit 9, the battery control unit 10, the engine control unit 11, and the steering control unit 12 based on the input travel information such as a vehicle behavior command, and outputs the calculated command values to a group of drive devices such as the inverter control unit 9, the battery control unit 10, the engine control unit 11, and the steering control unit 12 using the communication path 8. The drive device group controls actuators (not illustrated) such as an inverter, a battery, a power generation engine, and a steering according to the input command values.

The inverter control unit 9 drives a motor via an inverter. The battery control unit 10 controls charging and discharging of a battery. The engine control unit 11 drives the power generation engine based on a power generation command value from the drive device command generation unit 6 to charge the battery. The steering control unit 12 controls the steering based on the command value from the drive device command generation unit 6.

FIG. 2 is a block diagram of the autonomous driving control unit 4.

The autonomous driving control unit 4 includes a trajectory generation unit 20, a driving scene determination unit 21, a vehicle motion control unit 22, and a communication interface 23.

The trajectory generation unit 20 generates a trajectory to avoid a collision with an object and is comfortable to ride based on the travel environment of the vehicle acquired by the first recognition device 1, the second recognition device 2, and the third recognition device 3, and outputs the trajectory to the vehicle motion control unit 22. The vehicle motion control unit 22 generates and outputs a command value for following the input trajectory. The driving scene determination unit 21 determines a driving scene, such as a road type, which is either an expressway or a normal road, a travel lane such as an inside lane and an overtaking lane, and a slope level such as an upward slope and a downward slope, based on travel environment information of the vehicle acquired by the first recognition device 1, the second recognition device 2, and the third recognition device 3. The communication interface 23 outputs the input information to the drive device command generation unit 6.

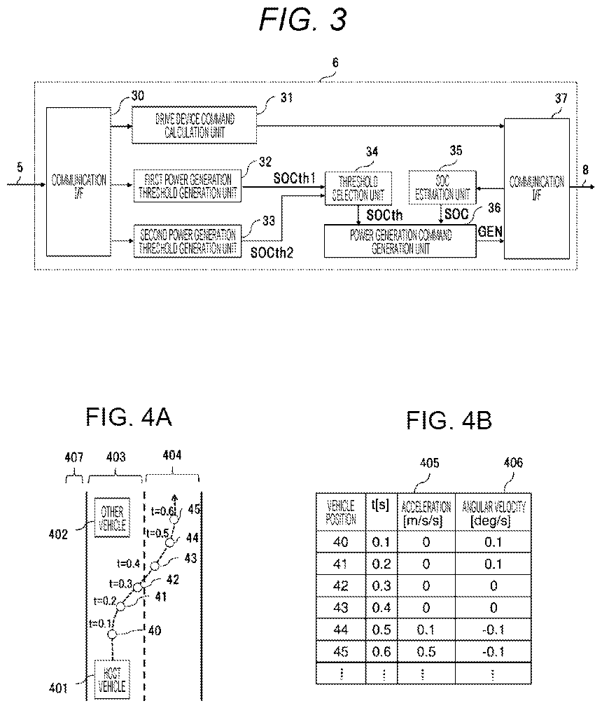

FIG. 3 is a block diagram of the drive device command value generation unit 6.

The drive device command value generation unit 6 includes a communication interface 30, a drive device command calculation unit 31, a first power generation threshold generation unit 32, a second power generation threshold generation unit 33, a threshold selection unit 34, an SOC estimation unit 35, a power generation command generation unit 36, and a communication interface 37.

The drive device command calculation unit 31 calculates command values for controlling the inverter control unit 9, the battery control unit 10, the engine control unit 11, and the steering control unit 12 based on a command value output from the vehicle motion control unit 22.

The first power generation threshold generation unit 32 outputs a first charging threshold SOCth1 set according to predicted regenerative energy. Specifically, the first charging threshold SOCth1 is set to a low value when the vehicle is scheduled to travel on a downhill or an expressway and the predicted regenerative energy is large, and is set to a high low value when the vehicle is scheduled to travel on an uphill or a general road and the predicted regenerative energy is small. Information on a travel environment in which the vehicle is scheduled to travel is provided by the driving scene determination unit 21.

The second power generation threshold generation unit 33 outputs a second charging threshold SOCth2 set according to energy necessary for a limp-home operation. Specifically, the second charging threshold SOCth2 is set to be high when the vehicle travels on a travel lane far from an evacuation road and energy necessary for the necessary limp-home operation is large, and is set to be low when the vehicle travels on a travel lane close to the evacuation road and the energy necessary for the limp-home operation is small.

The threshold selection unit 34 selects a larger one of the first charging threshold SOCth1 and the second charging threshold SOCth2, and outputs the selected value as a charging threshold SOCth. The SOC estimation unit 35 estimates a state of charge (SOC) of the battery based on battery information acquired from the battery control unit 10. Note that the SOC estimation unit 35 may be provided in the battery control unit 10. When the charging threshold SOCth exceeds the SOC of the battery, the power generation command generation unit 36 turns on a power generation command value GEN for the engine control unit 11. When the power generation command value GEN is turned on, the engine control unit 11 starts the power generation engine to charge the battery.

Note that the autonomous driving control unit 4 and the drive device command value generation unit 6 are illustrated as the block diagrams in FIGS. 2 and 3, but may be realized by a computer including a CPU, a memory, and the like and a program.

In addition, all the functions or some functions may be achieved by a hard logic circuit. Further, this program can be provided in the state of being stored in advance in a storage medium of the driving control device 100. Alternatively, the program can be provided in the state of being stored in an independent storage medium, or the program can be recorded and stored in a storage medium of the driving control device 100 via a network line. The program may be supplied as various forms of computer-readable computer program products such as a data signal (carrier wave).

FIGS. 4(A) and 4(B) are views illustrating an example of the trajectory in a case of overtaking a preceding vehicle.

FIG. 4(A) illustrates the trajectory of the vehicle on a road. As illustrated in FIG. 4(A), when a host vehicle 401 overtakes another vehicle 402, it is assumed that a lane is changed from a first travel lane (inside lane) 403 on which the host vehicle 401 is traveling to a second travel lane (overtaking lane) 404 and acceleration is performed. In this example, future vehicle positions 40 to 45 of the host vehicle 401 are illustrated at intervals of 0.1 seconds.

FIG. 4(B) is an example of the vehicle behavior command value for following the trajectory illustrated in FIG. 4(A), and a future acceleration 405 and an angular velocity 406 are set at intervals of 0.1 seconds for the respective vehicle positions 40 to 45. In this example, the host vehicle 401 changes the lane to the second travel lane 404 and accelerates from the vehicle position 44.

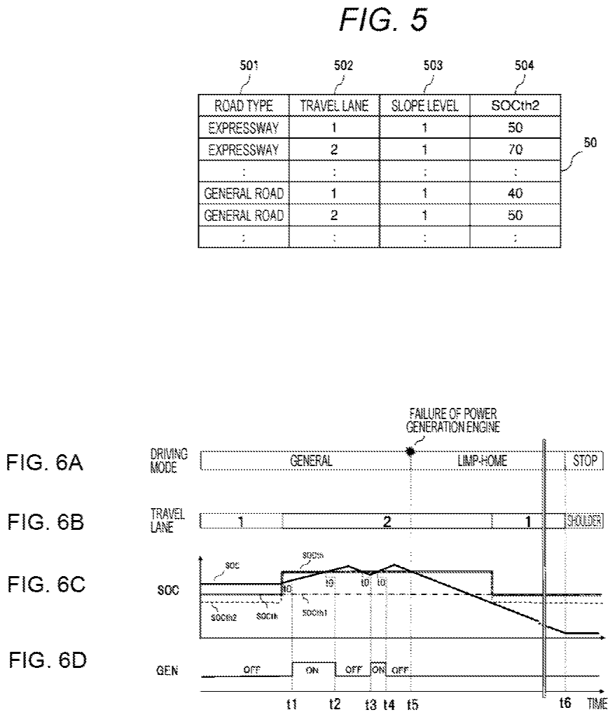

FIG. 5 is a view illustrating a lookup table 50 referred to by second power generation threshold generation unit 33. The lookup table 50 may be stored in the second power generation threshold generation unit 33 or may be stored in another storage unit. The lookup table 50 stores, in advance, a second charging threshold SOCth2 504 in association with a road type 501 on which the vehicle travels, a travel lane 502 on which the vehicle travels, and a slope level 503 of the road on which the vehicle travels.

The second power generation threshold generation unit 33 refers to the lookup table 50 based on driving scenes, such as a road type, which is an expressway or a normal road, a travel lane such as an inside lane and an overtaking lane, and a slope level such as an upward slope and a downward slope, transmitted from the driving scene determination unit 21. Then, the second charging threshold SOCth2 504 associated with the road type 501, the travel lane 502, and the slope level 503 that match the driving scenes is read and output.

For example, as illustrated in FIG. 4(A), when the vehicle is traveling on a normal slope of the first travel lane 403 of the expressway, the second power generation threshold generation unit 33 reads 50 as the second charging threshold SOCth2 504 illustrated in FIG. 5. When the vehicle is traveling on a normal slope of the second travel lane 404 of the expressway, the second power generation threshold generation unit 33 reads 70 as the second charging threshold SOCth2 504 illustrated in FIG. 5. In addition, when the vehicle is traveling on a normal slope of the first travel lane 403 of the normal road, the second power generation threshold generation unit 33 reads 40 as the second charging threshold SOCth2 504 illustrated in FIG. 5. When the vehicle is traveling on a normal slope of the second travel lane 404 of the normal road, the second power generation threshold generation unit 33 reads 50 as the second charging threshold SOCth2 504 illustrated in FIG. 5. In addition, in the lookup table 50, the second charging threshold SOCth2 is set to be high when the upward slope continues, and the second charging threshold SOCth2 is set to be low when the downward slope continues. Note that an evacuation road 407 is set on the left lane side of the first travel lane 403 as illustrated in FIG. 4(A).

In this manner, the second charging threshold SOCth2 is set to be high when the vehicle travels on a travel lane far from the evacuation road 407 or the like and a large amount of energy is required for the limp-home operation, and is set to be low when the vehicle travels on a travel lane close to the evacuation road 407 or the like and the energy for the limp-home operation is small.

FIG. 6 is a view for describing selection of a charging threshold according to a travel lane of the vehicle.

FIG. 6(A) illustrates a lapse of time in a driving mode of the vehicle. FIG. 6(B) illustrates the travel lane of the vehicle. FIG. 6(C) illustrates the SOC of the battery, the selected charging threshold SOCth, the first charging threshold SOCth1, and the second charging threshold SOCth2. FIG. 6(D) illustrates an on/off state of the power generation command value GEN. In each drawing, the horizontal axis represents time.

As illustrated in FIGS. 6(A) and 6(B), the vehicle is traveling on the first travel lane 403 in a normal driving mode. When the vehicle is traveling on the first travel lane 403, the second power generation threshold generation unit 33 refers to the lookup table 50 illustrated in FIG. 5 and reads 50 as the second charging threshold SOCth2. As illustrated in FIG. 6(C), the first charging threshold SOCth1 indicated by an alternate long and short dash line in the drawing is larger than the second charging threshold SOCth2 indicated by a dotted line in the drawing, and thus, the threshold selection unit 34 outputs the first charging threshold SOCth1 as the selected charging threshold SOCth indicated by a double line in the drawing. At this time, the SOC of the battery is higher than the charging threshold SOCth, and thus, the power generation command value GEN is turned off, the power generation engine is not started, and the battery is not charged.

Next, it is assumed that the vehicle has changed the travel lane to the second travel lane 404 by overtaking or the like between time t1 and t0. The second power generation threshold generation unit 33 refers to the lookup table 50 illustrated in FIG. 5 and reads 70 as the second charging threshold SOCth2. Then, the second charging threshold SOCth2 is larger than the first charging threshold SOCth1 as illustrated in FIG. 6(C), and thus, the threshold selection unit 34 outputs the second charging threshold SOCth2 as the selected charging threshold SOCth. At this time, the SOC of the battery is lower than the charging threshold SOCth, and thus, the power generation command value GEN is turned on at time t1, and the power generation engine is started to charge the battery. As a result, when the vehicle is traveling on the second travel lane which is far from the evacuation road 407, a large amount of energy is required for the limp-home operation for returning to the evacuation road 407, and thus, the battery can be sufficiently charged. Note that time t0 is a time interval provided to avoid a phenomenon in which a comparison result between the SOC of the battery and the charging threshold SOCth is frequently switched in a short period of time.

Next, the SOC of the battery becomes higher than the charging threshold SOCth between time t2 and t0, and thus, the power generation command value GEN is turned off at time t2, the power generation engine is not started, and the battery is not charged. This indicates a case where sufficient charging corresponding to the energy of the limp-home operation for returning to the evacuation road 407 is performed in the battery by traveling in the second travel lane for a certain period of time.

Next, when the SOC of the battery becomes lower than the charging threshold SOCth between time t3 and t0, the power generation command value GEN is turned on at time t3, the power generation engine is started to charge the battery. This indicates a case where the battery is charged again when the SOC of the battery is lowered during traveling on the second travel lane.

Next, the SOC of the battery becomes higher than the charging threshold SOCth between time t4 and t0, and thus, the power generation command value GEN is turned off at time t4, the power generation engine is not started, and the battery is not charged. This indicates a case where sufficient charging corresponding to the energy of the limp-home operation for returning to the evacuation road 407 is performed in the battery by traveling in the second travel lane for a certain period of time.

Next, it is assumed that the power generation engine fails at time t5. The failure of the power generation engine is notified from the host control device (not illustrated) to the autonomous driving control unit 4, and the autonomous driving control unit 4 changes the driving mode to the limp-home mode. The vehicle changes the travel lane from the second travel lane to the first travel lane, and then, changes the first travel lane to the evacuation road 407. Then, the vehicle finally stops on a road shoulder.

In this manner, when the vehicle travels on the second travel lane, sufficient charging corresponding to the energy for the limp-home operation for returning to the evacuation road 407 is performed in the battery, and thus, the vehicle can reliably perform the limp-home operation.

According to the above-described embodiment, the following operational effects are obtained.

(1) The driving control device 100 includes: the autonomous driving control unit 4 that calculates the vehicle behavior information of the autonomous driving vehicle based on the travel environment information from the first to third recognition devices 1 to 3 that recognize the external environment of the vehicle; and the drive device command generation unit 6 that outputs the command values for controlling the battery or the power generation engine based on the vehicle behavior information from the autonomous driving control unit 4. The drive device command generation unit 6 outputs the power generation command value to the power generation engine by comparing the charging rate SOC of the battery with the charging threshold SOCth defined based on the travel environment information of the vehicle by the first to third recognition devices 1 to 3. As a result, it is possible to perform charging control on the battery necessary for travel in the limp-home mode according to the travel environment of the vehicle.

The present invention is not limited to the above-described embodiment, and other modes, which are conceivable inside a scope of a technical idea of the present invention, are also included in a scope of the present invention as long as characteristics of the present invention are not impaired.

### REFERENCE SIGNS LIST

100 driving control device
1 first recognition device
2 second recognition device
3 third recognition device
4 autonomous driving control unit
6 drive device command generation unit
9 inverter control unit
10 battery control unit
11 engine control unit
12 steering control unit
20 trajectory generation unit
21 driving scene determination unit
22 vehicle motion control unit
23,30,37 communication interface
31 drive device command calculation unit
32 first power generation threshold generation unit
33 second power generation threshold generation unit
34 threshold selection unit
35 SOC estimation unit
36 power generation command generation unit

1. A driving control device comprising:
an autonomous driving control unit that calculates vehicle behavior information of an autonomous driving vehicle based on travel environment information from a recognition device that recognizes an external environment of the vehicle; and
a drive device command generation unit that outputs a command value for controlling a battery or a power generation engine based on the vehicle behavior information from the autonomous driving control unit,
wherein the drive device command generation unit outputs a power generation command value to the power generation engine by comparing a charging rate SOC of the battery with a charging threshold SOCth defined based on the travel environment information of the vehicle obtained by the recognition device.

2. The driving control device according to claim 1, wherein the drive device command generation unit outputs the power generation command value when the charging threshold SOCth exceeds the charging rate SOC of the battery.

3. The driving control device according to claim 2, wherein the power generation engine is started based on the power generation command value to charge the battery.

4. The driving control device according to claim 1, wherein as the charging threshold SOCth, a larger one of a first charging threshold SOCth1 defined according to predicted regenerative energy and a second charging threshold SOCth2 defined according to energy necessary for a limp-home operation is selected.

5. The driving control device according to claim 4, wherein the first charging threshold SOCth1 is set to a low value when the vehicle is scheduled to travel on a downhill or an expressway and the predicted regenerative energy is large, and is set to be a high value when the vehicle is scheduled to travel on an uphill or a general road and the predicted regenerative energy is small.

6. The driving control device according to claim 4, wherein the second charging threshold SOCth2 is set to be high when the vehicle travels on a travel lane far from an evacuation road and the energy necessary for the limp-home operation is large, and is set to be low when the vehicle travels on a travel lane close to the evacuation road and the energy necessary for the limp-home operation is small.
